(19) United States
(12) Patent Application Publication
(10) Pub. No.: US 2026/0009438 A1
(43) Pub. Date: Jan. 8, 2026

(54) ELECTRIC BRAKE DEVICE

(71) Applicant: ADVICS CO., LTD, Kariya-shi, Aichi-ken (JP)

(72) Inventor: Satoshi HIRATA, Kariya-shi, Aichi-ken (JP)

(73) Assignee: ADVICS CO., LTD., Kariya-shi, Aichi-ken (JP)

(21) Appl. No.: 18/993,028

(22) PCT Filed: Aug. 3, 2023
(86) PCT No.: PCT/JP2023/028375

§ 371 Date: Jan. 10, 2025

(30) Foreign Application Priority Data
Aug. 3, 2022 (JP) 2022-123974

(51) Int. Cl. F16D 65/18; F16D 121/24; H02K 11/215; H02K 11/30

(52) U.S. Cl. CPC F16D 65/18; H02K 11/215; H02K 11/30; F16D 2121/24

(57) ABSTRACT

An electric brake device includes an actuator section. The actuator section applies a braking force to a wheel according to rotation of an electric motor transmitted by a transmission mechanism. The electric brake device includes a circuit section that controls the actuator section. The electric brake device includes a rotation angle sensor configured by a detected section attached to a motor shaft member and a detecting section provided to the circuit section. The electric brake device includes a partition wall that defines a first space in which the transmission mechanism is arranged and a second space in which the circuit section is arranged. The partition wall is provided with a through-hole. The detected section is arranged in the through-hole.

### TECHNICAL FIELD

The disclosure here relates to an electric brake device.

### BACKGROUND ART

A brake device that includes a non-contact sensor for detecting a rotation angle of an electric motor is disclosed in PTL 1. The brake device disclosed in PTL 1 includes a partition wall (Trennmittel) for protecting electronic components from foreign substances such as wear debris and a lubricant. A shaft of the electric motor and a sensor element are arranged in a manner to sandwich the partition wall.

### CITATION LIST

### Patent Literature

PTL 1: DE-A-102009046044

### SUMMARY

### Technical Problem

In the brake device as disclosed in PTL 1, since the partition wall is arranged between a magnet attached to the shaft and the sensor element, a problem arises that the magnet and the sensor element are distanced from each other. This may lower detection accuracy of the sensor.

### Solution to Problem

An electric brake device for solving the above problem includes: a transmission mechanism that transmits rotation of a motor shaft member in an electric motor; an actuator section that moves a friction member according to rotation of the electric motor transmitted by the transmission mechanism, presses the friction member against a rotary body that rotates together with a wheel, and thereby applies a braking force to the wheel; a circuit section that controls the actuator section; a rotation angle sensor that is configured by a detected section attached to the motor shaft member and a detecting section provided to the circuit section to detect output from the detected section and that detects a rotation angle of the electric motor; and a partition wall that defines a first space as a space in which the transmission mechanism is arranged and a second space as a space in which the circuit section is arranged, and the gist thereof is that the partition wall is provided with a hole that is a through-hole or a blind hole, and that, among at least a part of the rotation angle sensor and a part of the motor shaft member, at least one thereof is arranged in the hole.

In the above configuration, since the partition wall is provided with the hole, the detected section and the detecting section, which constitute the rotation angle sensor, can easily be arranged close to each other despite arrangement of the partition wall that defines the first space, in which the transmission mechanism is arranged, and the second space, in which the circuit section is arranged. Thus, it is possible to arrange the detecting section at a position where magnetic flux density is relatively high despite the arrangement of the partition wall. As a result, it is possible to suppress entry of foreign substances, such as wear debris and a lubricant, into the second space by the partition wall while alleviating lowering of detection accuracy of the rotation angle sensor.

### BRIEF DESCRIPTION OF DRAWINGS

FIG. 1 is a partial cross-sectional view illustrating an electric brake device in a first embodiment.

FIG. 2 is a partial cross-sectional view illustrating the electric brake device in the first embodiment.

FIG. 3 is a cross-sectional view illustrating an electric brake device in a second embodiment.

FIG. 4 is a cross-sectional view illustrating an electric brake device in a modified example.

FIG. 5 is a cross-sectional view illustrating an electric brake device in another modified example.

FIG. 6 is a cross-sectional view illustrating an electric brake device in further another modified example.

FIG. 7 is a cross-sectional view illustrating an electric brake device in yet another modified example.

FIG. 8 is a cross-sectional view illustrating an electric brake device as a modified example that includes a bearing in a hole of a partition wall.

FIG. 9 is a cross-sectional view illustrating an electric brake device as a modified example that includes a grommet in a hole of a partition wall.

FIG. 10 is a front view of the grommet that is provided to the electric brake device in FIG. 9.

FIG. 11 is a cross-sectional view illustrating an electric brake device as a modified example that includes a thin film closing a through-hole of a partition wall.

FIG. 12 is a cross-sectional view illustrating an electric brake device as another modified example that includes a thin film closing a through-hole of a partition wall.

FIG. 13 is a cross-sectional view illustrating an electric brake device as a modified example that includes a blind hole in a partition wall.

FIG. 14 is a cross-sectional view illustrating an electric brake device as another modified example that includes a blind hole in a partition wall.

### DESCRIPTION OF EMBODIMENTS

### First Embodiment

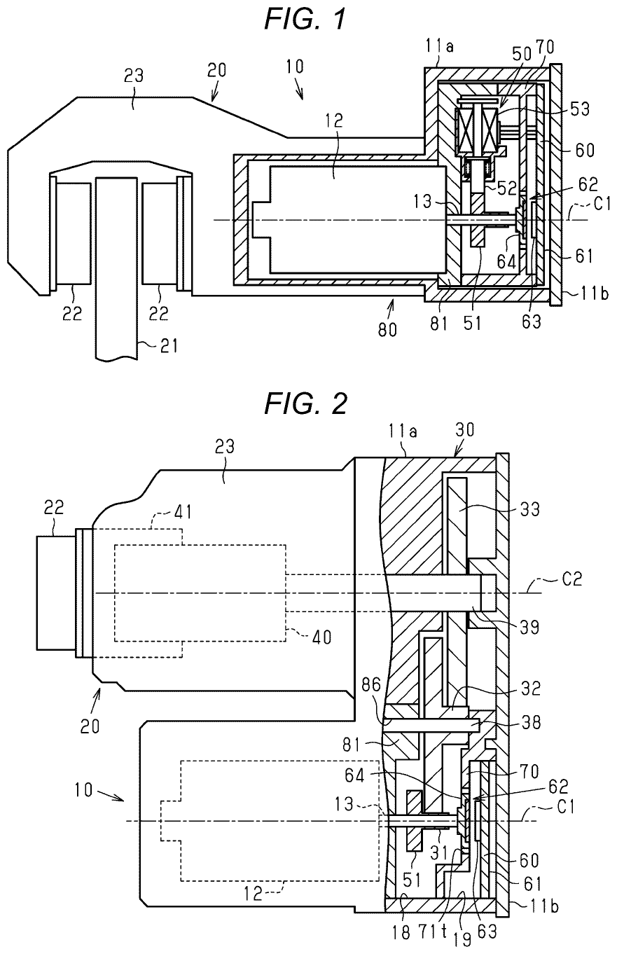

A description will be made on an electric brake device 10 as a first embodiment of the electric brake device with reference to FIG. 1 to FIG. 2.

### <Electric Brake Device>

The electric brake device 10 includes a transmission mechanism 30 that transmits rotation of a motor shaft member 13 in an electric motor 12. The electric brake device 10 includes an actuator section 20. The actuator section 20 moves a friction member 22 according to rotation of the electric motor 12 transmitted by the transmission mechanism 30, presses the friction member 22 against a rotary body 21 that rotates together with a wheel, and thereby applies a braking force to the wheel. The electric brake device 10 includes a circuit section 60 that controls the actuator section 20. The electric brake device 10 includes a rotation angle sensor 62 that is configured by a detected section 64 attached to the motor shaft member 13 and a detecting section 63 provided to the circuit section 60 to detect output from the detected section 64 and that detects a rotation angle of the electric motor 12. The electric brake device 10 includes a partition wall 70 that defines a first space as a space in which the transmission mechanism 30 is arranged and a second space as a space in which the circuit section 60 is arranged. The partition wall 70 is provided with a through-hole 71t. At least a part of the rotation angle sensor 62 is arranged in the through-hole 71t.

FIG. 1 and FIG. 2 each illustrate the electric brake device 10. The electric brake device 10 includes a case 11a, a cover 11b, and a caliper housing 23. The cover 11b closes an opening of the case 11a. The caliper housing 23 is attached to the case 11a. The case 11a is sealed.

The electric brake device 10 includes the actuator section 20. As illustrated in FIG. 1, the actuator section 20 includes the friction member 22 that can be pressed against the rotary body 21 rotating together with the wheel of a vehicle. The rotary body 21 is a brake disc, for example. The actuator section 20 can generate the larger braking force as a force that presses the friction member 22 against the rotary body 21 is increased.

The electric brake device 10 includes the electric motor 12. In FIG. 1 and FIG. 2, a line along an axis of the motor shaft member 13 in the electric motor 12 is illustrated as an input axis C1.

As illustrated in FIG. 2, the actuator section 20 includes a conversion mechanism 40 that converts rotary motion of the electric motor 12 into linear motion. The conversion mechanism 40 is a feed screw that is configured by a screw shaft and a nut, for example. The actuator section 20 includes a piston 41, and the friction member 22 is attached to an end portion thereof toward the rotary body 21. The conversion mechanism 40 and the piston 41 are housed in the caliper housing 23. The actuator section 20 can move the piston 41, that is, the friction member 22 by the linear motion, into which the rotary motion of the electric motor 12 is converted by the conversion mechanism 40. One of directions in which the piston 41 is moved by the linear motion is a direction in which the friction member 22 attached to the piston 41 is brought closer to the rotary body 21. The other of the directions in which the piston 41 is moved by the linear motion is a direction in which the friction member 22 attached to the piston 41 is moved away from the rotary body 21.

As illustrated in FIG. 2, the actuator section 20 includes the transmission mechanism 30 that transmits the rotary motion of the electric motor 12 to the conversion mechanism 40. The transmission mechanism 30 may include a speed reduction mechanism. An example of the transmission mechanism 30 will be described.

The transmission mechanism 30 is configured by a combination of a gear and the like. The transmission mechanism 30 includes an input gear 31. For example, the input gear 31 is attached to the motor shaft member 13. The input gear 31 may be configured by forming teeth on a surface of the motor shaft member 13. The transmission mechanism 30 includes an output gear 33. The transmission mechanism 30 includes an output shaft member 39. The output gear 33 is attached to the output shaft member 39. In FIG. 2, a line along an axis of the output shaft member 39 is illustrated as an output axis C2. An example of the transmission mechanism 30 is configured that the output axis C2 is positioned in parallel to the input axis C1.

The transmission mechanism 30 may include an intermediate gear 32. The transmission mechanism 30 may include an intermediate shaft member 38, to which the intermediate gear 32 is attached. For example, the intermediate gear 32 includes: a first gear section that can mesh with the input gear 31; and a second gear section that can mesh with the output gear 33. In the intermediate gear 32, the first gear section and the second gear section rotate together. In an example of the intermediate gear 32, as illustrated in FIG. 2, the first gear section and the second gear section are molded as one unit. For example, the transmission mechanism 30 may include a first intermediate gear and a second intermediate gear as separate members. The first intermediate gear corresponds to the first gear section that can mesh with the input gear 31, and the second intermediate gear corresponds to the second gear section that can mesh with the output gear 33. A plurality of the intermediate gears may be attached to the intermediate shaft member 38.

In the transmission mechanism 30, the rotation of the motor shaft member 13 is input to the input gear 31. The output gear 33 can rotate in response to rotation of the input gear 31. The output gear 33 transmits rotation to the actuator section 20 via the output shaft member 39. More specifically, when the input gear 31 meshes with the first gear section of the intermediate gear 32, the rotary motion of the electric motor 12 can be transmitted from the motor shaft member 13 to the intermediate shaft member 38. Then, when the second gear section of the intermediate gear 32 meshes with the output gear 33, the rotary motion of the electric motor 12 can be transmitted from the intermediate shaft member 38 to the output shaft member 39. The output shaft member 39 is coupled to the conversion mechanism 40. When the output gear 33 causes the output shaft member 39 to rotate, the rotary motion is transmitted to the conversion mechanism 40.

In FIG. 2, the single intermediate gear 32 is exemplified. However, as the transmission mechanism 30, plural gears, each of which contributes to transmission of the rotary motion, may be interposed between the input gear 31 and the output gear 33.

The electric brake device 10 includes the circuit section 60. The circuit section 60 has a processing circuit that controls the rotary motion of the electric motor 12. The circuit section 60 can control the actuator section 20 through control of the electric motor 12. The circuit section 60 is housed in the case 11a. For example, the circuit section 60 includes a circuit board 61 and mounted components that are mounted on the circuit board 61. FIG. 1 and FIG. 2 each illustrate an example in which the circuit section 60 is attached such that the input axis C1, which is the line along the axis of the motor shaft member 13, intersects the circuit section 60. More specifically, the circuit section 60 is arranged such that the input axis C1 and the circuit board 61 are orthogonal to each other.

The electric brake device 10 includes the rotation angle sensor 62 for detecting a rotation angle of the motor shaft member 13. An example of the rotation angle sensor 62 is a non-contact sensor. The non-contact sensors include a magnetic sensor.

The electric brake device 10 includes the partition wall 70 in the case 11a. For example, in the case 11a, the partition wall 70 can define a housing section for housing the circuit section 60. More specifically, the partition wall 70 can define a first housing section 18, in which the electric motor 12 is housed, and a second housing section 19, in which the circuit section 60 is housed. The transmission mechanism 30 is housed in the first housing section 18. An internal space of the first housing section 18 corresponds to the “first space”. An internal space of the second housing section 19 corresponds to the “second space”.

As illustrated in FIG. 1, the electric brake device 10 may include a rotation stop mechanism 50. The rotation stop mechanism 50 can maintain the braking force that is applied by the actuator section 20. For example, a parking brake function can be implemented by operating the rotation stop mechanism 50. The rotation stop mechanism 50 includes, for example, a solenoid section 53 and an engagement section 52 that can be moved by the solenoid section 53. For example, the rotation stop mechanism 50 is housed in the first housing section 18.

An example of the rotation stop mechanism 50 functions as a ratchet mechanism. In this case, together with a ratchet gear 51 that is attached to the motor shaft member 13, the rotation stop mechanism 50 constitutes the ratchet mechanism. For example, the ratchet gear 51 is molded together with the input gear 31. As another example, as a different member from the input gear 31, the ratchet gear 51 may be attached to the motor shaft member 13. When the engagement section 52 that has come into contact with the ratchet gear 51 meshes with teeth of the ratchet gear 51, rotation of the ratchet gear 51 is stopped. By stopping the rotation of the ratchet gear 51, the rotation stop mechanism 50 can stop the rotation of the electric motor 12. The rotation stop mechanism 50 can stop the rotation in a direction of reducing the braking force among rotational directions of the electric motor 12. In this way, the rotation stop mechanism 50 can maintain the braking force that is applied to the wheel by the actuator section 20. Meanwhile, the rotation stop mechanism 50 can allow the rotation in a direction of increasing the braking force among the rotational directions of the electric motor 12. The rotation stop mechanism 50 can cancel the maintenance of the braking force by releasing meshing between the engagement section 52 and the ratchet gear 51.

The solenoid section 53 of the rotation stop mechanism 50 includes a solenoid terminal. The solenoid terminal is connected to the circuit section 60, for example. The solenoid terminal is inserted through a through-hole for a terminal, which is formed in the partition wall 70, for example, and is thereby connected to the circuit section 60 through the partition wall 70. As another example, the solenoid terminal may be connected to the circuit section 60 via a connector and a wire, or the like. A path that connects the solenoid terminal and the circuit section 60 is not limited to one that penetrates the partition wall 70, and may bypass the partition wall 70.

The electric brake device 10 may include a motor bracket 81. For example, the electric motor 12 and the rotation stop mechanism 50 are attached to the motor bracket 81. The motor bracket 81 may include a transmission shaft hole 86. A shaft member that is provided to the transmission mechanism 30 can be inserted through the transmission shaft hole 86. For example, as illustrated in FIG. 2, the intermediate shaft member 38 can be inserted through the transmission shaft hole 86.

The motor bracket 81 is fixed to the case 11a. That is, the electric motor 12 is fixed via the motor bracket 81. In addition, the rotation stop mechanism 50 is fixed via the motor bracket 81. In the electric brake device 10, the electric motor 12 and the rotation stop mechanism 50 are integrated by the motor bracket 81 to constitute a parking brake unit 80. The parking brake unit 80 is housed in the case 11a.

### <Rotation Angle Sensor>

As illustrated in FIG. 1 and FIG. 2, the rotation angle sensor 62 is configured by the detecting section 63 and the detected section 64. For example, the detecting section 63 is mounted on the circuit board 61. The detected section 64 is attached to the motor shaft member 13. The detecting section 63 is arranged at a position opposing the detected section 64. As an example, a diameter of the detected section 64 is larger than a diameter of the motor shaft member 13.

As an example of the rotation angle sensor 62, the detected section 64 includes a magnet. For example, the detected section 64 includes a holder to which the magnet is attached. In this case, the magnet is attached to the motor shaft member 13 via the holder. As an example, the detecting section 63 is a sensor element that detects a change in a magnetic field generated by the magnet rotating together with the motor shaft member 13.

### <Partition Wall>

As illustrated in FIG. 1 and FIG. 2, the partition wall 70 is formed with the through-hole 71t. The through-hole 71t is a hole for arranging at least a part of the rotation angle sensor 62 therein. FIG. 1 and FIG. 2 each illustrate an example in which the detected section 64 of the rotation angle sensor 62 is arranged in the through-hole 71t. The detecting section 63 of the rotation angle sensor 62 may be arranged in the through-hole 71t. The detected section 64 and the detecting section 63 may be arranged in the through-hole 71t.

The first housing section 18 and the second housing section 19 are connected by the through-hole 71t. In other words, a path that connects the first housing section 18 and the second housing section 19 is formed by a clearance that is located between the detected section 64 and the partition wall 70 formed with the through-hole 71t.

Preferably, a diameter of the through-hole 71t is slightly larger than the diameter of the detected section 64 so as to reduce the clearance between the detected section 64 arranged in the through-hole 71t and the partition wall 70 formed with the through-hole 71t. That is, the path that connects the first housing section 18 and the second housing section 19 preferably has a small cross-sectional area.

For example, a center of the through-hole 71t is located on the input axis C1.

For example, the through-hole 71t is formed to have the constant diameter from a surface of the partition wall 70 facing the first housing section 18 to a surface of the partition wall 70 facing the second housing section 19.

An example of the partition wall 70 has permeability to allow magnetic flux to pass therethrough. An example of the partition wall 70 is molded from a nonmagnetic material. Examples of the nonmagnetic material include a synthetic resin material and an aluminum alloy.

In the electric brake device 10, the partition wall 70 is preferably positioned such that the detected section 64 is arranged in the through-hole 71t. For example, the motor bracket 81 and the partition wall 70 are preferably fixed by a pin. The disclosure is not limited thereto. Of the partition wall 70, the motor bracket 81, the case 11a, and the cover 11b, members that contact each other may be fixed by a pin or the like.

### <Manufacturing Method for Electric Brake Device>

In a manufacturing method for the electric brake device 10, first, a step of attaching the detected section 64 to the motor shaft member 13 of the electric motor 12 is performed. Next, a step of attaching the electric motor 12 to the case 11a is performed. Then, a step of attaching the partition wall 70 is performed.

A specific description will be made on an example of the manufacturing method for the electric brake device 10. First, a step of attaching the electric motor 12 to the motor bracket 81 is performed. Next, a step of attaching the ratchet gear 51, the input gear 31, and the detected section 64 to the motor shaft member 13 is performed. Then, a step of attaching the rotation stop mechanism 50 to the motor bracket 81 is performed. After the above steps, the parking brake unit 80, in which the electric motor 12, the rotation stop mechanism 50, and the motor bracket 81 are integrated, is assembled. Next, a step of attaching the parking brake unit 80, in which the electric motor 12, the rotation stop mechanism 50, and the motor bracket 81 are integrated, to the case 11a is performed. For example, the parking brake unit 80 is attached to the case 11a by inserting the electric motor 12 through the opening of the case 11a from an end surface on an opposite side of the electric motor 12 from an end surface, from which the motor shaft member 13 protrudes. Then, after the transmission mechanism 30, the partition wall 70, and the circuit section 60 are attached to the case 11a, the cover 11b is attached to the case 11a to close the opening of the case 11a. At this time, the partition wall 70 is attached such that the detected section 64, which is attached to the motor shaft member 13, is inserted through the through-hole 71t. By inserting the intermediate shaft member 38 of the transmission mechanism 30 through the transmission shaft hole 86, the intermediate shaft member 38 can be supported by the motor bracket 81.

### <Operation and Effects of First Embodiment>

A description will be made on operation and effects of the first embodiment.

According to the electric brake device 10, the partition wall 70 can suppress entry of the foreign substances, such as wear debris and a lubricant, into the second housing section 19 from the first housing section 18, in which the transmission mechanism 30 as a possible source of the foreign substances is housed. In this way, it is possible to protect the circuit section 60, which is housed in the second housing section 19, against the foreign substances.

In the electric brake device 10, the detected section 64 is arranged in the through-hole 71t that is formed in the partition wall 70. In this way, the detected section 64 and the detecting section 63 can easily be arranged close to each other despite the arrangement of the partition wall 70 that defines the first housing section 18, which houses the transmission mechanism 30, and the second housing section 19, which houses the circuit section 60, in the case 11a. Thus, it is possible to arrange the detecting section 63 at a position where magnetic flux density is relatively high despite the arrangement of the partition wall 70. As a result, it is possible to suppress the entry of the foreign substances, such as the wear debris and the lubricant, into the second housing section 19 while alleviating lowering of detection accuracy of the rotation angle sensor 62.

In the electric brake device 10, the path that connects the first housing section 18 and the second housing section 19 has the small cross-sectional area by reducing the clearance between the partition wall 70 and the detected section 64 arranged in the through-hole 71t. This makes it difficult for the foreign substances to pass through the through-hole 71t although the through-hole 71t is formed in the partition wall 70.

### Second Embodiment

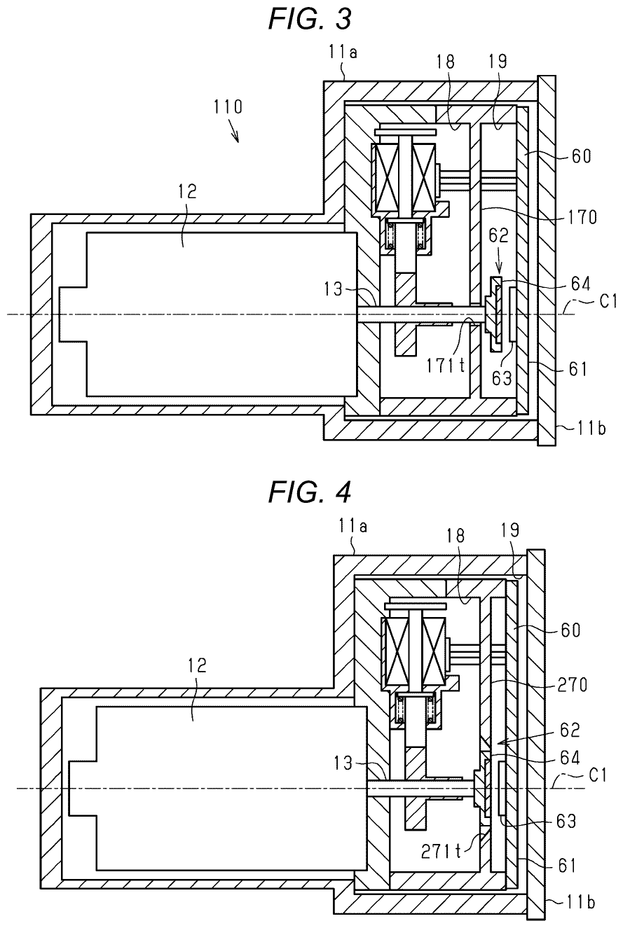

FIG. 3 illustrates an electric brake device 110 in a second embodiment.

The electric brake device 110 in the second embodiment differs from the electric brake device 10 in the first embodiment described above in that the motor shaft member 13 is arranged in a through-hole 171t. Components of the electric brake device 110 that are common to those of the electric brake device 10 will be denoted by the same reference signs in the first embodiment, and the description thereon will not be made as appropriate.

As illustrated in FIG. 3, the motor shaft member 13 is inserted through the through-hole 171t of a partition wall 170. Preferably, a diameter of the through-hole 171t is slightly larger than the diameter of the motor shaft member 13.

Since the motor shaft member 13 is arranged in the through-hole 171t, in the electric brake device 110, the detected section 64 is arranged in the second housing section 19.

In a manufacturing method for the electric brake device 110, first, a step of attaching the electric motor 12 to the case 11a is performed. Next, a step of attaching the partition wall 170 is performed. Then, a step of attaching the detected section 64 to the motor shaft member 13 of the electric motor 12 is performed.

### <Operation and Effects of Second Embodiment>

According to the electric brake device 110 in the second embodiment, operation and effects that are common to those of the electric brake device 10 in the first embodiment are exerted.

The electric brake device 110 further exerts the following operation and effects.

In the electric brake device 110, the through-hole 171t, which has the larger diameter than the motor shaft member 13, only needs to be formed in the partition wall 170. For this reason, compared to the through-hole 71t, which is provided in the case of the first embodiment, the diameter of the through-hole 171t can be reduced. This makes it more difficult for the foreign substances to pass through the through-hole 171t.

In the electric brake device 110, the detected section 64 is arranged in the second housing section 19 that houses the circuit section 60. Thus, the detected section 64 and the detecting section 63 can be arranged much closer to each other.

### Modified Examples

Each of the above embodiments can be modified and implemented as follows. Each of the above embodiments and the following modified examples can be implemented in combination with each other unless technically contradictory.

### [Shape of Partition Wall Having Through-Hole]

· In the first embodiment described above, the through-hole 71t that has the constant diameter is exemplified. The through-hole that is formed in the partition wall is not limited thereto.

A partition wall 270 illustrated in FIG. 4 is formed with a through-hole 271t. The through-hole 271t is formed such that a diameter thereof is gradually reduced from a surface of the partition wall 270 facing the first housing section 18 to a surface of the partition wall 270 facing the second housing section 19. That is, the through-hole 271t has a tapered shape that is tapered from the first housing section 18 toward the second housing section 19. A diameter of a portion having the smallest diameter in the through-hole 271t is slightly larger than the diameter of the detected section 64. The configuration illustrated in FIG. 4 can exert an effect that the foreign substances that have entered the through-hole 271t from the first housing section 18 are bounced back into the first housing section 18 by the tapered shape.

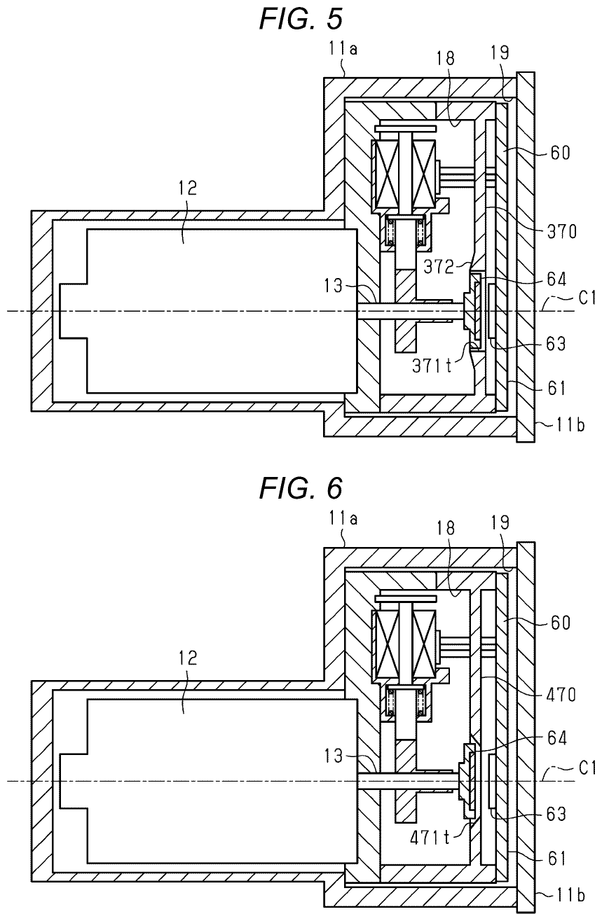

· A partition wall 370 illustrated in FIG. 5 is formed with a through-hole 371t. Similar to the through-hole 71t in the first embodiment, the through-hole 371t has a constant diameter. The partition wall 370 is gradually thickened toward an edge of the through-hole 371t. That is, the partition wall 370 has an inclined surface 372 that is inclined to approach the electric motor 12 as being closer to the edge of the through-hole 371t. According to the configuration illustrated in FIG. 5, since the foreign substances that move from the first housing section 18 toward the through-hole 371t climb the inclined surface 372, this makes it difficult for the foreign substances to enter the through-hole 371t.

· A partition wall 470 illustrated in FIG. 6 is formed with a through-hole 471t. The through-hole 471t is common to the through-hole 271t exemplified in FIG. 4 in a point of having a tapered shape that is tapered from the first housing section 18 toward the second housing section 19. A diameter of a portion having the smallest diameter in the through-hole 471t is smaller than the diameter of the detected section 64. Compared to the first embodiment, the detected section 64 is shifted closer to the electric motor 12. In this way, in a direction in which the axis of the motor shaft member 13 extends, a part of the partition wall 470 overlaps the detected section 64. The configuration illustrated in FIG. 6, makes it more difficult for the foreign substances, which move from the first housing section 18 toward the second housing section 19, to pass through the through-hole 471t.

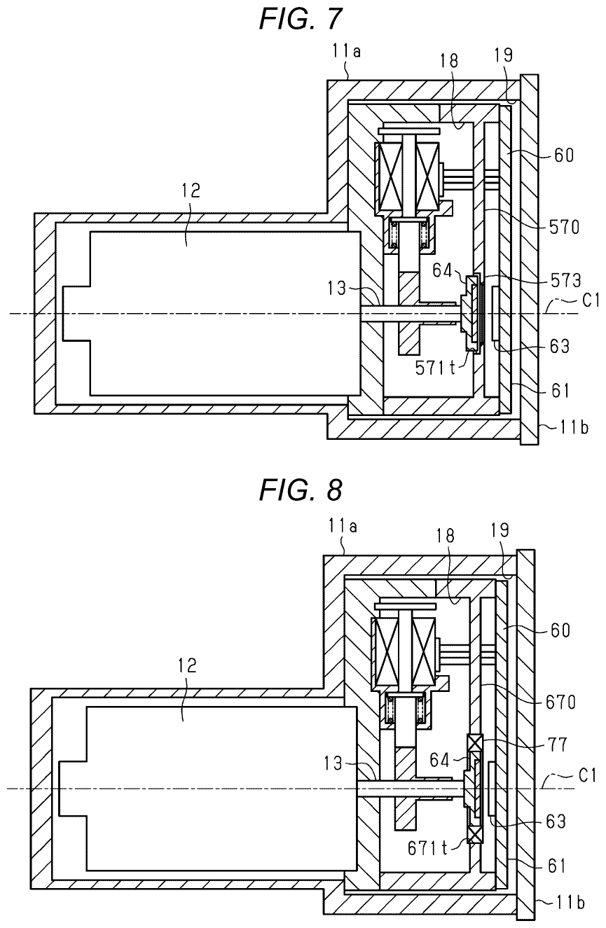

· A partition wall 570 illustrated in FIG. 7 is formed with a through-hole 571t. On a surface facing the second housing section 19, the partition wall 570 has a reduced diameter section 573 that extends from an edge of the through-hole 571t toward a center of the through-hole 571t. In the partition wall 570, a diameter of the through-hole 571t from a surface facing the first housing section 18 to the reduced diameter section 573 is constant. A hole having a smaller diameter than the above diameter is formed in the reduced diameter section 573. In the reduced diameter section 573, a surface facing the input axis C1 may be tapered. In the configuration illustrated in FIG. 7, a path that is formed by a clearance between the detected section 64 and the partition wall 570 formed with the through-hole 571t and that connects the first housing section 18 and the second housing section 19 is bent. More specifically, the path is bent in a radial direction of the through-hole 571t from the direction in which the axis of the motor shaft member 13 extends. In addition, with provision of the reduced diameter section 573, the reduced diameter section 573, which is a part of the partition wall 570, overlaps the detected section 64 in the direction in which the axis of the motor shaft member 13 extends. The configuration illustrated in FIG. 7 makes it more difficult for the foreign substances, which move from the first housing section 18 toward the second housing section 19, to pass through the through-hole 571t.

· The configuration of the partition wall formed to bend the above path is not limited to that exemplified in FIG. 7. The member arranged in the through-hole and the partition wall only need to be configured that the path is bent at least at one point.

### [Attachment of Member to Through-Hole]

· As illustrated in FIG. 8, a bearing 77 that is fixed to a partition wall 670 in a manner to be arranged in a through-hole 671t may be provided. The bearing 77 is a rolling bearing, a plain bearing, or the like. The bearing 77 rotatably supports the detected section 64. In this case, the detected section 64 corresponds to a supported section. The through-hole 671t is closed by the bearing 77 and the detected section 64 that is supported by the bearing 77. Thus, according to the configuration illustrated in FIG. 8, it is possible to further suppress the entry of the foreign substances from the first housing section 18 into the second housing section 19.

· A bearing may be applied to the through-hole 171t in the second embodiment described above. That is, the bearing may rotatably support the motor shaft member 13. In this case, the motor shaft member 13 corresponds to the supported section. Just as described, among at least a part of the detected section 64 and a part of the motor shaft member 13, a portion arranged in the hole is the supported section, and the bearing only needs to rotatably support the supported section.

The partition wall may include: the bearing that supports the detected section 64 arranged in the through-hole; and the bearing that supports the motor shaft member 13 arranged in the through-hole.

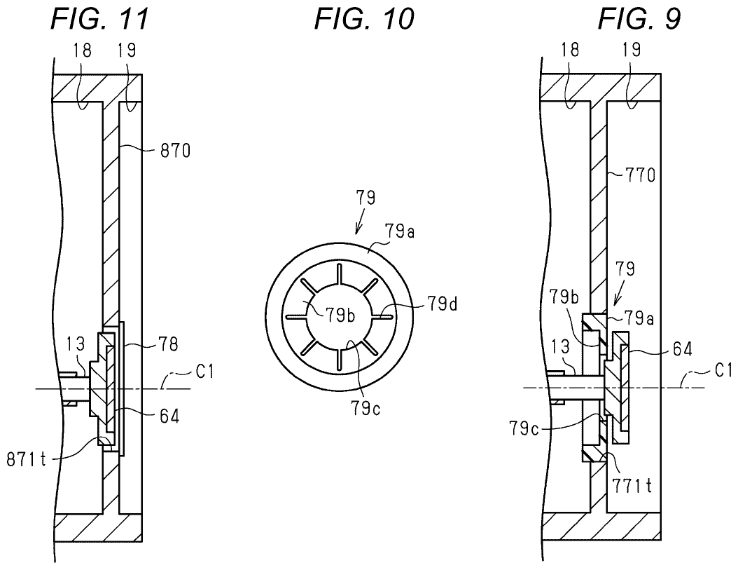

· As illustrated in FIG. 9 and FIG. 10, a grommet 79 that is fitted into a through-hole 771t may be provided. The through-hole 771t is formed in a partition wall 770.

An example of the grommet 79 is elastically deformable. The grommet 79 is made of rubber, for example. A description will be made on the grommet 79 in a state of fitted into the through-hole 771t. The grommet 79 includes an edge section 79a that is fitted into the through-hole 771t. On a surface facing the second housing section 19, the grommet 79 has a cover section 79b that extends from the edge section 79a toward a center of the through-hole 771t. A thickness of the cover section 79b is less than a thickness of the edge section 79a. The thickness of the cover section 79b is less than a thickness of the partition wall 770. The cover section 79b is formed with a center hole 79c. A diameter of the center hole 79c is smaller than the diameter of the detected section 64. The diameter of the center hole 79c is larger than the diameter of the motor shaft member 13. The cover section 79b may be formed with a radial slit 79d from the center hole 79c toward the edge section 79a. A width, a length, and the like of the slit 79d are not particularly limited. In addition, the appropriate number of the slits 79d can be formed in the cover section 79b.

In the example illustrated in FIG. 9, the motor shaft member 13 is arranged in the through-hole 771t. More specifically, the motor shaft member 13 is inserted through the center hole 79c of the grommet 79 that is fitted into the through-hole 771t.

A description will be made on a manufacturing method for the electric brake device exemplified in FIG. 9. First, the step of attaching the detected section 64 to the motor shaft member 13 of the electric motor 12 is performed. Next, the step of attaching the electric motor 12 to the case 11a is performed. Then, the step of attaching the partition wall 770 is performed. Here, since the cover section 79b is elastically deformed, the detected section 64 can pass through the center hole 79c of the grommet 79.

According to the above configuration, since the grommet 79 includes the cover section 79b and the center hole 79c, it is possible to reduce the cross-sectional area of the path that connects the first housing section 18 and the second housing section 19. Since the cover section 79b is elastically deformed, it is possible to attach the detected section 64 to the motor shaft member 13 and then attach the partition wall 70 despite the configuration that the motor shaft member 13 is arranged in the through-hole 771t. Since the cover section 79b is formed with the slit 79d, the detected section 64 can easily pass through the center hole 79c in comparison with a case where the slit 79d is not formed.

· As illustrated in FIG. 11, a thin film 78 may be attached to close a through-hole 871t. The through-hole 871t is formed in a partition wall 870. A thickness of the thin film 78 is less than a thickness of the partition wall 870. The thin film 78 is permeable. The thin film 78 is made of resin, for example. In the example illustrated in FIG. 11, the thin film 78 is attached to a surface of the partition wall 870 facing the second housing section 19.

According to the above configuration, similar to the first embodiment described above, the detected section 64 and the detecting section 63 can easily be arranged close to each other despite the arrangement of the partition wall 70. Furthermore, since the through-hole 871t is closed by the thin film 78, it is possible to suppress the entry of the foreign substances into the second housing section 19.

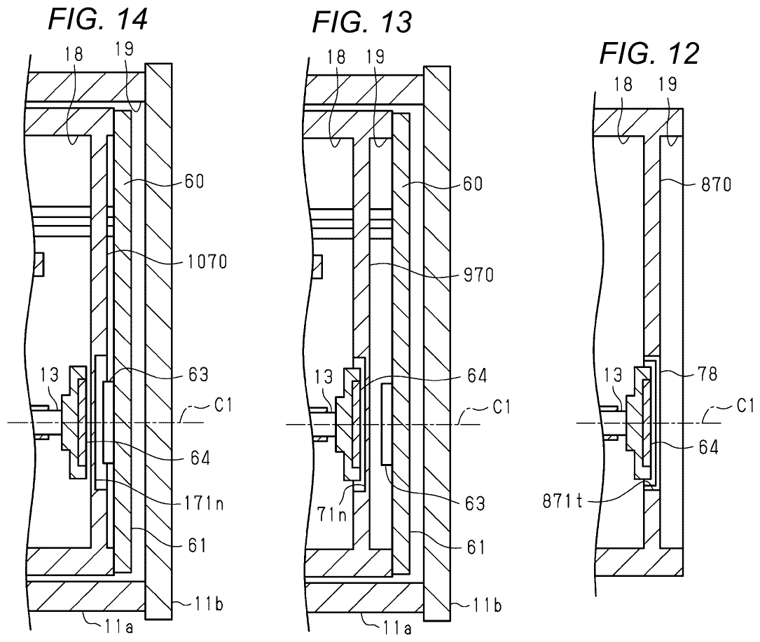

· As illustrated in FIG. 12, the thin film 78, which closes the through-hole 871t, may be attached to an inner wall of the through-hole 871t. For example, the thin film 78 may be press-fitted into the through-hole 871t.

Alternatively, for example, a configuration as illustrated in FIG. 12 can be adopted when, instead of the grommet 79 exemplified in FIG. 9 and FIG. 10, a grommet that includes neither the center hole 79c nor the slit 79d is fitted into the through-hole 871t. That is, the through-hole 871t may be closed not by the thin film 78 but by a cover section of the grommet.

### [Partition Wall Having Blind Hole]

· In the first embodiment and the second embodiment described above, the through-hole has been exemplified as the hole formed in the partition wall. The hole that is formed in the partition wall is not limited to the through-hole and may be a blind hole. An example thereof will be described with reference to FIG. 13.

FIG. 13 illustrates an example in which a blind hole 71n, a surface of which facing the first housing section 18 is recessed toward a surface facing the second housing section 19, is formed in a partition wall 970. That is, the partition wall 970 is thinned in a portion formed with the blind hole 71n. The detected section 64 can be arranged in the blind hole 71n. In this way, it is possible to adopt a configuration that the detecting section 63 and the detected section 64 are aligned in the direction in which the axis of the motor shaft member 13 extends.

According to the above configuration, similar to the first embodiment described above, the detected section 64 and the detecting section 63 can easily be arranged close to each other despite the arrangement of the partition wall 970. Furthermore, since the hole in which the detected section 64 is arranged is the blind hole 71n, it is possible to further suppress the entry of the foreign substances into the second housing section 19.

· FIG. 14 illustrates another example of the blind hole. FIG. 14 illustrates an example in which a blind hole 171n, a surface of which facing the second housing section 19 is recessed toward a surface facing the first housing section 18, is formed in a partition wall 1070. The detecting section 63 can be arranged in the blind hole 171n.

· A bearing can also be attached to the blind hole 71n as exemplified in FIG. 13. This bearing can support the detected section 64.

· The partition wall may be formed with both the blind hole as exemplified in FIG. 13 and the blind hole as exemplified in FIG. 14. That is, the partition wall may be formed with both the blind hole, the surface of which facing the first housing section 18 is recessed toward the surface facing the second housing section 19, and the blind hole, the surface of which facing the second housing section 19 is recessed toward the surface facing the first housing section 18. According to this configuration, it is possible to further thin the portion, which is formed with the blind holes, in the partition wall.

· The partition wall may be formed with a through-hole that is a combination of a through-hole and a blind hole. For example, on a bottom of the blind hole as exemplified in FIG. 13, a through-hole having a smaller diameter than a diameter of the blind hole may be formed. In other words, the configuration exemplified in FIG. 7 is a configuration that includes a hole as the combination of the blind hole and the through-hole.

[Arrangement Mode of Rotation Angle Sensor]

· In the first embodiment and the second embodiment described above, the detecting section 63 of the rotation angle sensor 62 is arranged at a position facing the detected section 64. Here, in the present specification, the detecting section 63 facing the detected section 64 means that the detecting section 63 and the detected section 64 are aligned in the direction in which the axis of the motor shaft member 13 extends. That is, another member such as a non-magnetic body may be arranged between the detecting section 63 and the detected section 64. For example, as in the configurations exemplified in FIG. 11 and FIG. 12, a member that closes the through-hole may be provided. For example, as in the configurations exemplified in FIG. 13 and FIG. 14, the detecting section 63 and the detected section 64 may be arranged to sandwich a thinned portion of the partition wall.

### [Positional Relationship Between Motor Shaft Member and Detected Section]

· In the first embodiment and the second embodiment described above, the configuration that the detected section 64 is attached to the end of the motor shaft member 13 is exemplified. However, the disclosure is not limited thereto, and the detected section may be attached to the motor shaft member such that the motor shaft member penetrates the detected section. That is, the detected section being attached to the end of the motor shaft member is not the essential configuration. The detected section only needs to be attached to the end of the motor shaft member.

In addition, the gear such as the input gear is attached to the end of the motor shaft member, and the detected section may be attached to an end on an opposite side of the gear from the motor shaft member side. That is, the detected section being directly attached to the motor shaft member is not the essential configuration. A member that is interposed between the detected section and the motor shaft member may be provided.

### [Relationship Between Rotation Angle Sensor and Motor Shaft Member With Respect To Hole]

· That “among at least a part of a rotation angle sensor and a part of a motor shaft member, at least one thereof is arranged in a hole” means the following configuration; a configuration that “at least a part of the rotation angle sensor is arranged in the hole”, a configuration that “a part of the motor shaft member is arranged in the hole”, or a configuration that “both at least a part of the rotation angle sensor and a part of the motor shaft member are arranged in the hole”.

Here, “of the rotation angle sensor and the motor shaft member, a portion arranged in the through-hole” is referred to as an insertion section.

In addition, the expression “at least a part of the rotation angle sensor” means only the detected section, only the detecting section, or both of the detected section and the detecting section. In this case, “the detected section” may be the entire detected section or may be a part of the detected section. “The detecting section” may be the entire detecting section or may be a part of the detecting section.

· From the combination of the above options, the electric brake device can be configured as follows.

The entire detected section is arranged in the through-hole. The detected section is partially arranged in the through-hole. The first embodiment described above is an example of such a configuration.

The entire detecting section is arranged in the through-hole. The detecting section is partially arranged in the through-hole.

The motor shaft member is arranged in the through-hole. The second embodiment described above is an example of such a configuration.

The detected section and the motor shaft member are arranged in the through-hole. For example, the configuration as described above can be adopted when the thickness of the partition wall is greater than the thickness of the detected section.

The detecting section and the motor shaft member are arranged in the through-hole. For example, the configuration as described above can be adopted when the motor shaft member penetrates the detected section.

The entire detected section is arranged in the blind hole. The detected section is partially arranged in the blind hole. The modified example exemplified in FIG. 13 is an example of such a configuration.

The entire detecting section is arranged in the blind hole. The detecting section is partially arranged in the blind hole. The modified example exemplified in FIG. 14 is an example of such a configuration.

The detected section and the motor shaft member are arranged in the blind hole. For example, the configuration as described above can be adopted when the thickness of the blind hole is greater than the thickness of the detected section.

The motor shaft member is arranged in the blind hole. The detecting section and the motor shaft member are arranged in the blind hole. For example, the configuration as described above can be adopted when the motor shaft member penetrates the detected section.

1. An electric brake device comprising:
a transmission mechanism that transmits rotation of a motor shaft member in an electric motor;
an actuator section that moves a friction member according to rotation of the electric motor transmitted by the transmission mechanism, presses the friction member against a rotary body that rotates together with a wheel, and thereby applies a braking force to the wheel;
a circuit section that controls the actuator section;
a rotation angle sensor that is configured by a detected section attached to the motor shaft member and a detecting section provided to the circuit section to detect output from the detected section and that detects a rotation angle of the electric motor; and
a partition wall that defines a first space as a space in which the transmission mechanism is arranged and a second space as a space in which the circuit section is arranged, wherein
the partition wall is provided with a hole that is a through-hole or a blind hole, and
among at least a part of the rotation angle sensor and a part of the motor shaft member, at least one thereof is arranged in the hole.

2. The electric brake device according to claim 1, wherein
the hole is the through-hole, and, of the rotation angle sensor and the motor shaft member, a portion arranged in the through-hole is an insertion section,
a clearance that is located between the insertion section and the partition wall formed with the through-hole forms a path that connects the first space and the second space, and
the insertion section and the partition wall are configured such that the path is bent at least at one point.

3. The electric brake device according to claim 1 further comprising:
a bearing that is provided to the partition wall and rotatably supports a portion of at least one of the detected section and the motor shaft member, the portion being arranged in the hole.
